(19) United States
(12) Patent Application Publication
(10) Pub. No.: US 2026/0275780 A1
(43) Pub. Date: Sep. 17, 2026

(54) CURVED TWO-SEGMENT FOLDABLE CONNECTING ROD

(71) Applicant: TECHNICAL AIRBORNE COMPONENTS INDUSTRIES, Herstal (BE)

(72) Inventor: Mathieu Chenoux, Arlon (BE)

(73) Assignee: TECHNICAL AIRBORNE COMPONENTS INDUSTRIES, Herstal (BE)

(21) Appl. No.: 19/166,615

(22) PCT Filed: Mar. 1, 2024
(86) PCT No.: PCT/EP2024/055343

§ 371 Date: Sep. 18, 2025

(30) Foreign Application Priority Data
Mar. 23, 2023 (BE) BE2023/5226

(51) Int. Cl. E05C 17/32; F16C 11/10

(52) U.S. Cl. CPC E05C 17/32; F16C 11/10

(57) ABSTRACT

A system (1) with a foldable, two-segment connecting rod (2) having a rectilinear locking segment (3) and a free segment (4), the two segments being connected together at their articulation end (3b, 4b) and the fastening ends (3a, 4a) making the connection between the foldable connecting rod (2), a frame (1a) and an opening panel (1c). The free segment (4) includes a rectilinear portion (4c) extending from its articulation end (4b), and a locking slide (7) is able to slide along the locking segment (3) and the rectilinear portion (4c). Moreover, the free segment (4) includes a curved portion (4d) as a continuation of the rectilinear portion (4c), this curved portion (4d) stopping the slide (7) in the locking position and allowing the free segment (4) to occupy a minimal amount of space.

### TECHNICAL FIELD

The invention relates to a two-segment foldable connecting rod system, one of these segments being curved. Such a connecting rod can be used for door leaves as a leaf retaining rod when unfolded and as a storage connecting rod when folded.

In the aeronautical field in particular, cowlings and hatches are movable leaf parts of the external structure of an aircraft which, when opened, allow access to elements or equipment—landing gear, engine—of the internal structure for inspection and/or maintenance operations. To carry out these operations, these cowlings and hatches are attached to connecting rods which keep the leaf open and prevent the cowling or hatch from closing unexpectedly. For the closing of the cowlings and hatches, the connecting rods are folded and accompany the closing kinematics of the openings.

Such connecting rods can be used in any other field that uses leaf holding rods such as the automotive, naval or construction fields in particular.

### PRIOR ART

Generally speaking, a connecting rod is a straight connecting part between two other parts moving in relation to each other, the connecting rod making it possible to transmit and/or block a movement of one of these parts. In the case of connecting rods for leaves, their function is to block the leaf when it has reached the desired opening.

Single connecting rods are commonly used in the automotive industry. They usually deploy and latch on the hood of a vehicle to keep it open. These connecting rods have the disadvantage of being the size of the opening sought for the hood. The size of these connecting rods is therefore directly dependent on the desired opening of the hood and if this desired opening is larger than the size of the hood, it is problematic to store the connecting rod when the hood is closed.

To reduce the size of these single connecting rods, telescopic connecting rods are used. These have several segments that fit together and slide into each other to increase or decrease the size of the telescopic connecting rod. However, these telescopic connecting rods are composed of hollow segments to allow them to fit together, and these hollow segments have less structural rigidity compared to solid segments. Telescopic connecting rods are therefore limited to low loads. In addition, the cost and longer assembly times of such telescopic connecting rods reduce their appeal.

Folding rod type connecting rods reduce the longitudinal size of single connecting rods. The longitudinal size of two-segment folding rods depends directly on the folding angle between these segments: the closer the folding angle is to 90°, the smaller the longitudinal size. However, this reduction in longitudinal occupied space is accompanied by an increase in transverse occupied space.

Three-segment folding connecting rods are more commonly used: they have a double articulation blocked by a slider when the connecting rod is unfolded. As this double articulation is located in a median zone between the ends of the connecting rod, the folded connecting rod has minimal longitudinal and transverse occupied space. However, the double articulation mechanism as well as the kinematics of the locking slider make the three-segment folding connecting rod fragile. If the leaf is damaged, the operation of the leaf is compromised.

### SUMMARY OF THE INVENTION

In order to overcome the disadvantages of the prior art described above, the main objective of the invention is to improve the footprint of the two-segment folding connecting rods without generating the inherent fragility of three-segment connecting rods.

To do this, the invention provides for making a foldable connecting rod with two segments, one of which is curved and which also includes a locking mechanism at the junction between the two segments. Advantageously, this mechanism allows a spontaneous locking of the segments by a spring force when the connecting rod unfolds. In addition, the mechanism is unlocked without the use of any particular tools.

More specifically, the present invention relates to a two-segment folding rod system connected between a frame and a leaf. Each segment, a so-called locking segment and a so-called free segment, has an attaching end and a hinge end, the two segments being connected to each other at their hinge end by a rotation axis. The attachment ends of the segments provide the connection between the folding rod and the frame as well as between the folding rod and the leaf.

The locking segment is rectilinear and comprises in a central zone a blocking means of a return means, whereas the free segment has a rectilinear portion extending from its hinge end. A locking slider is adapted to slide along the locking segment and the rectilinear portion of the free segment between a release position and a locking position, the return means positioning the locking slider in the locking position. In the release position, the locking slider is carried entirety by the locking segment, and in the locking position, the locking slider covers the hinge ends.

More specifically, the free segment comprises a curved portion in continuity with the rectilinear portion, this curved portion making the locking slider stop in the locking position and allowing minimum bulk of the free segment.

Advantageously, the curved free segment allows for minimal bulk when folding the connecting rod while closing the leaf. This foldable connecting rod can thus participate in the opening/closing mechanism of a leaf when it is installed in a small space. In particular, the attachment points of the folding rod can be very close to each other.

Also advantageously, the curved portion of the free segment allows the slider to be locked when it comes to the locking position without machining the free segment nor adding an additional stop. The folding rod of the present invention is thus simplified and therefore faster to manufacture and easier to handle.

Depending on preferred embodiments taken alone or in combination:
the return means of the locking slider is a compression spring;
the locking means of the compression spring is a circular stop arranged on the locking segment;
the rectilinear portion of the free segment is smaller than the locking slider that covers the axis of rotation in the locking position;
the free segment comprises a stop for the locking slider;
the locking segment comprises a mortise and the free segment a tenon joined by the axis of rotation or vice versa;
the tenon comprises at least one shoulder;
at least one shoulder comprises a locking stop in rotation of the free segment;
at least one shoulder comprises a step at the end of rotation of the free segment;
at least one shoulder comprises a chamfer;
the mortise comprises at least one right angle against the rotating locking stop when the segments are aligned and at least one rounded edge that avoids the rotating locking stop;
the tenon comprises a corner abutting against a flat between the branches of the mortise in the locking position and a curve that avoids the flat.

### DESCRIPTION OF THE FIGURES

Other features and advantages of the present invention will be apparent from the following reading of an embodiment detailed without limiting its scope, with reference to the annexed figures which represent, respectively:

FIG. 1, a perspective view of an example of a folding rod system according to the invention holding a leaf in the closed position;

FIG. 2, a perspective view of the system in FIG. 1 when the leaf is in the open position;

FIG. 3, an exploded view of the components of the folding rod from the previous figures;

FIG. 4, a cross-sectional view of said folding connecting rod with the slider in the locking position;

FIG. 5, a side view of this folding rod with the slider in the locking position;

FIG. 6, a side view of the same folding rod with the slider in the release position;

FIG. 7, a side view of the said folding rod in a first folding position;

FIG. 8, a side view of this folding connecting rod in a second folding position;

FIG. 9, a side view of the same folding connecting rod in a final folding position, and

FIG. 10, a perspective view of the articulation between the segments of the said folding rod.

### DETAILED DESCRIPTION

On the figures, identical reference signs refer to the same element as well as to the corresponding passages of the description.

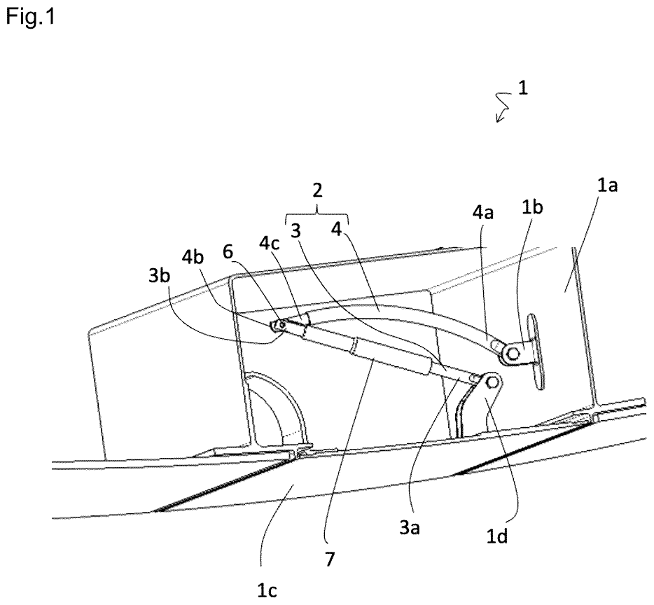

FIG. 1 shows a perspective view of an example according to the invention of a two-segment folding rod 2 system 1 in connection between a frame 1a and a leaf 1c, in this case an access hatch in the closed position. Each segment, a so-called locking segment 3 and a so-called free segment 4, has a attaching end 3a, 4a and a hinge end 3b, 4b, the two segments being connected to each other at their hinge end 3b, 4b by a rotation axis 6. The attachment ends 3a, 4a, locking segment 3 and free segment 4 respectively provide the connection between the folding rod 2 and the frame 1a as well as between the folding connecting rod 2 and the leaf 1c. Alternatively, the attachment ends 3a, 4a of the locking segment 3 and the free segment 4 respectively provide the connection between the folding rod 2 and the leaf 1c as well as between the folding connecting rod 2 and the frame 1a.

Each attachment end 3a, 4a is pivotally mounted in respectively a fixing support 1b of frame 1a and a support 1d of leaf 1c, respectively, these pivoting connections allowing the folding rod 2 to extend and fold together with the opening and closing of leaf 1c in its frame 1a. Locking segment 3 is rectilinear and comprises a locking slider 7 designed to slide along this locking segment 3. The locking slider 7 is in the so-called unlocking position and is carried entirely by the locking segment 3. The free segment 4 comprises a rectilinear portion 4c extending from its joint end 4b.

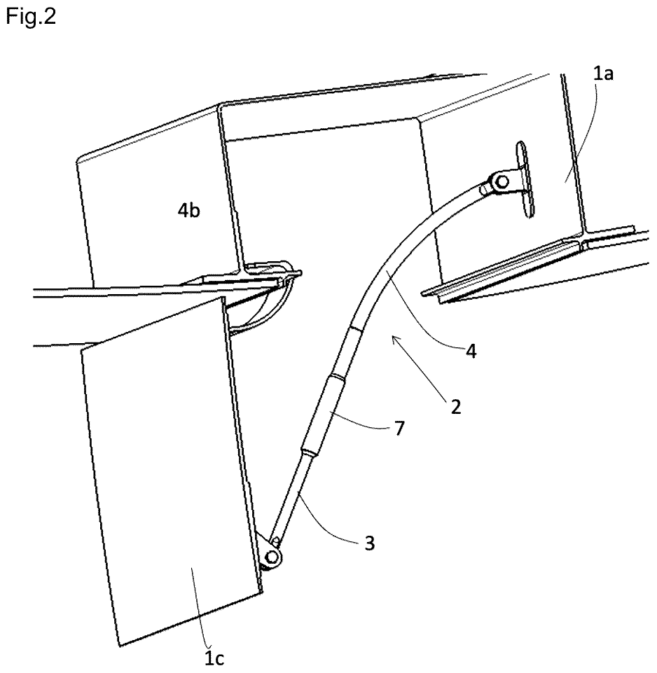

With reference to FIG. 2, the folding connecting rod 2 is shown in connection between frame 1a and leaf 1c when the latter is in the fully open position. The segments of the folding rod 2 are then in linear continuity with respect to each other and the locking slider 7, in the so-called locking position, also covers the rectilinear portion 4c of the free segment 4, as well as the hinge ends 3b, 4b.

With the hinge ends 3b, 4b covered, the folding rod 2 is locked in the extended configuration and therefore the leaf is then kept open. The rectilinear portion 4c of the free segment is advantageously smaller than the locking slider 7 which covers the axis of rotation 6 in the locking position in order to secure this locking.

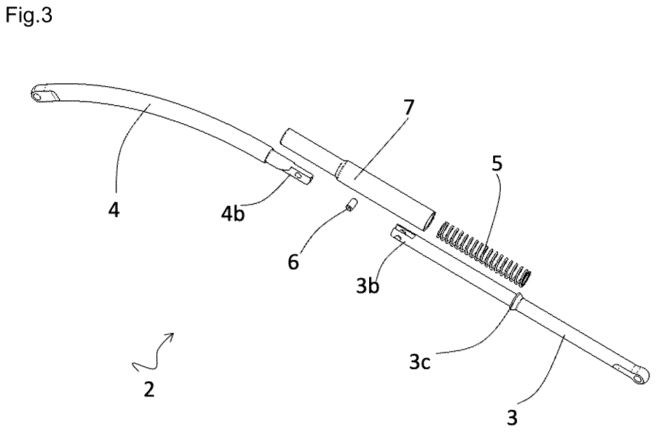

FIG. 3 shows an exploded view of the folding rod 2. This consists of locking segment 3, free segment 4, locking slider 7, rotation axis 6 and a compression spring 5 as a means of recalling locking slider 7. Locking segment 3 comprises a locking means of the compression spring 5 in a middle area between its ends. The locking means here is a circular stop 3c arranged on the locking segment 3. The folding connecting rod 2 is mounted in the following steps:
positioning the compression spring 5 around the locking segment 3 and stopping the compression spring 5 against the locking medium;
positioning the locking slider 7 on the compression spring 5;
pulling on the locking slider 7 to compress the compression spring 5 and release the hinge end 3b from the locking segment 3;
assembly of the hinge ends 3b, 4b of the locking segment 3 and the free segment 4 by the axis of rotation 6, and
release of the locking slider 7.

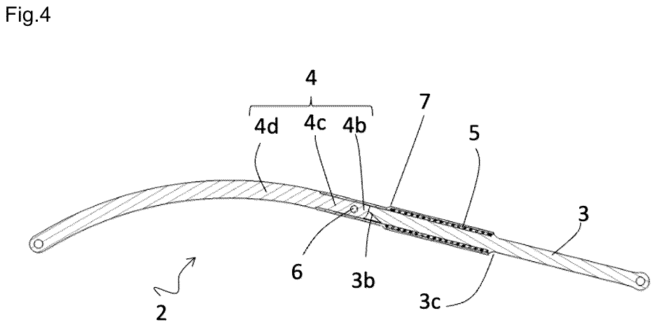

FIG. 4 shows a cross-sectional view of the folding rod 2 with the locking slider 7 in the locking position. In this cross-sectional view, the compression spring 5 is abutted against the locking means of the locking segment 3 and the locking slide 7 covers the hinge ends 3b, 4b of the locking segment 3 and the free segment 4. The foldable connecting rod 2 is then said to be in deployed configuration. The locking slider 7 is capable of sliding along the locking segment 3 and the rectilinear portion 4c of the free segment 4 between the release position and the locking position, with the compression spring 5 then positioning the locking slider 7 in the locking position. In addition, the free segment 4 has a curved portion 4d in continuity with the rectilinear portion 4c, this curved portion 4d making a stop of the locking slider 7 in the locking position and allowing a minimum footprint of free segment 4. Alternatively, the locking slider can be stopped in the locking position by means of a circlip or a stop ring installed on the locking slider and resting on the circular stop. This ensures that the locking slider is kept in the locking position, even if there is no stop on the free segment.

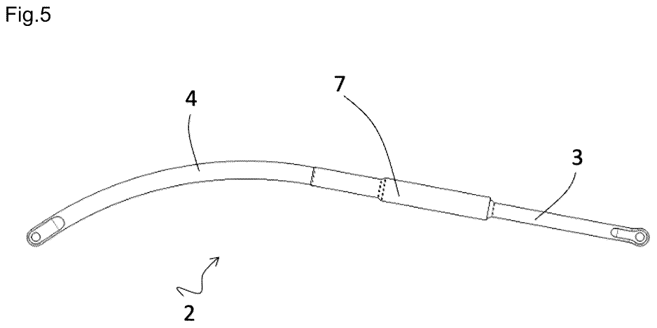

The side view in FIG. 5 shows the foldable connecting rod 2 in the extended configuration. In this configuration, also shown in FIG. 2, the locking slider 7 is in the locking position and prevents the folding rod 2 from folding by locking the hinge ends, which can no longer rotate around the axis of rotation.

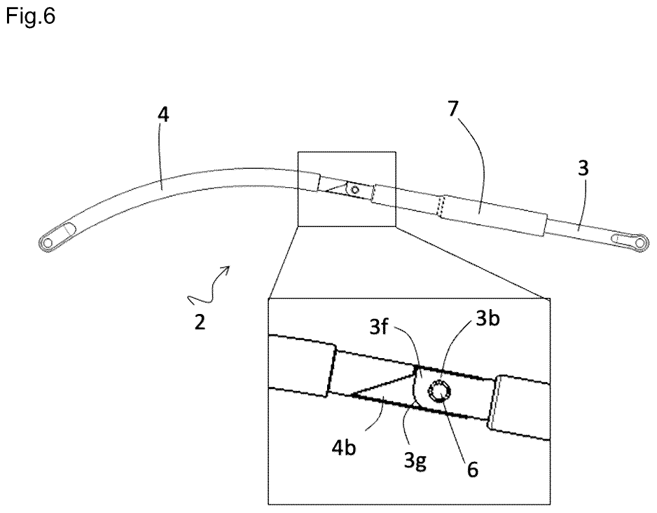

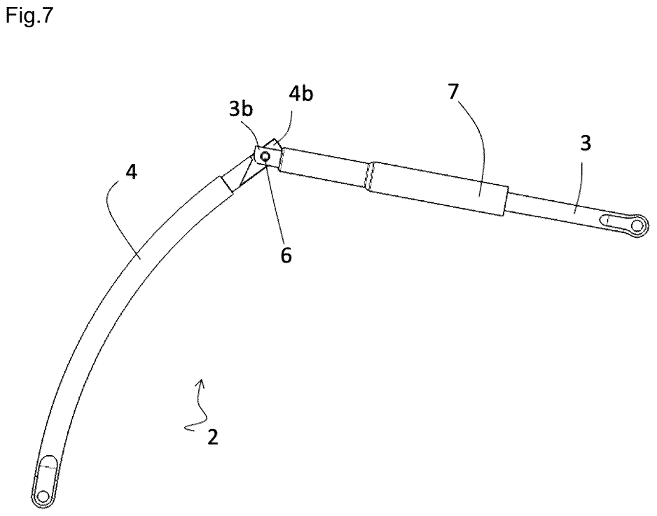

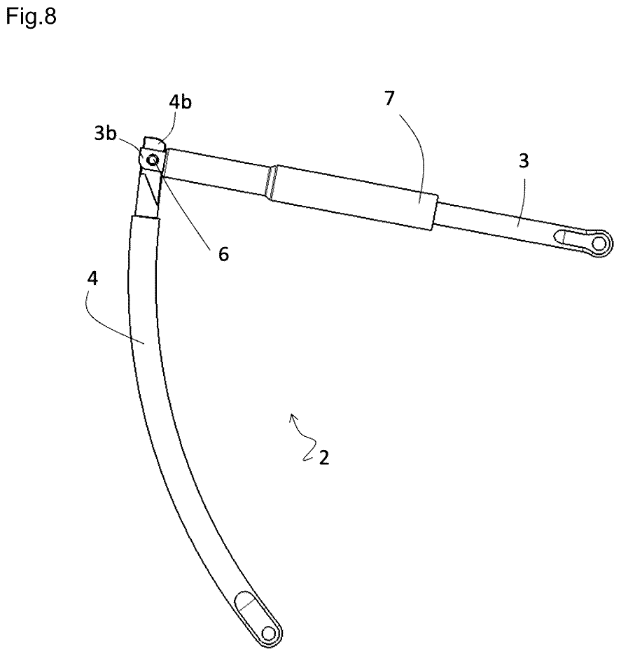

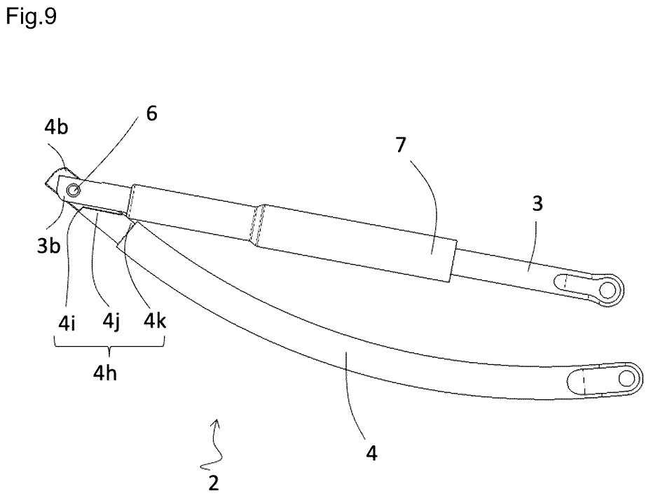

FIGS. 6 to 9 illustrate the different folding rod 2 folding steps. In FIG. 6, an operator pulls on the locking slider 7 to bring it to the unlocking position, thus releasing the ends of hinge 4b, 3b of the free segments 4 and locking 3. The segments can then rotate relative to each other around the axis of rotation 6, as shown in FIG. 7 and FIG. 8 which show different folding angles of the folding rod 2. In FIG. 9, the folding rod 2 is folded to its maximum and thus occupies a minimum of space.

The deployment and locking of the folding rod 2 is illustrated by considering FIGS. 9 to 5 backwards. With the folding rod 2 initially folded (FIG. 9), the free segment 4 and the locking segment 3 rotate relative to each other when the leaf opens (FIG. 8 and FIG. 7) until they align (FIG. 6). Then the compression spring 5 positions the locking slider 7 in the locking position (FIG. 5).

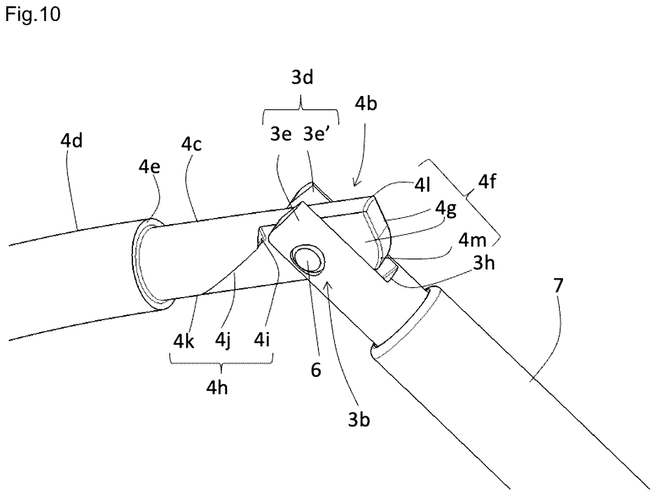

FIG. 10 shows a perspective view of the hinge ends 4b, 3b, the free segment 4, and the locking segment 3. In particular, the rectilinear portion 4c and the curved portion 4d of free segment 4 have different diameters. As the curved portion 4d is larger in diameter, it makes a stop 4e of the locking slider 7 when it comes along the rectilinear portion 4c in the locking position.

In addition, the assembly of the free segment 4 and the locking segment 3 is of the mortise tenon type in which locking segment 3 comprises the mortise 3d and the free segment 4 comprises the tenon4f, the mortise 3d and the tenon 4f being assembled together around the axis of rotation 6. Alternatively, locking segment 3 may comprise the tenon and free segment 4 may comprise the mortise or each segment may have an asymmetrical mortise. The tenon 4f has two opposite faces 4g and the 3d mortise has two identical 3rd, 3rd′ branches.

The tenon 4f on the free segment 4 comprises a shoulder 4h on each face 4g, each shoulder having a rotation blocking stop 4i of the free segment 4 and a step 4j for the end of rotation of the free segment 4. The operation of the rotational blocking stop 4i is detailed below with reference to FIG. 6 and FIG. 7.

Each branch 3e, 3e′ of the mortise 3d has a right angle 3f against the rotating locking stop 4i when the segments are aligned (FIG. 6). This right angle 3f helps prevent counterclockwise rotation of locking segment 3 around axis 6. The 3e and 3e′ branches of the mortise 3d also have a rounded edge 3g which avoids the rotation blocking stop 4i and which allows the locking segment 3 to rotate clockwise around the axis of rotation 6 (FIG. 7). The combination of the rotational blocking stop 4i and the mortise 3d geometry ensures that the segments only rotate between each other according to the predetermined folding kinematics.

The step 4j for the end of rotation of the free segment 4 creates a flat in contact with the mortise 3d and defines the maximum folding position of the folding rod 2. As shown in FIG. 9, when the folding rod 2 is folded and the access door is closed, the folding rod 2 does not reach this maximum folding position and a gap remains between the step 4j and the mortise 3d. Indeed, the closing of the access hatch limits the final folding position of the folding rod 2. In addition, each shoulder 4h also has a chamfer 4k at the end of the step 4j for the end of rotation of the free segment 4. This chamfer 4k is in contact with the locking slider 7 as also shown in FIG. 9 and helps to minimize damage to the locking slider 7 during successive deployments and folding of the folding rod 2.

The tenon 4f also comprises a right corner 4l and a rounded corner 4m, the right angle 4l coming to abut against the flat 3h between the branches 3e and 3e′ of the mortise 3d in the locking position. During the folding of the folding rod 2, the right corner 4l prevents the clockwise rotation of the free segment 3 around the axis of rotation 6, the counterclockwise rotation and therefore the folding of the folding rod 2 being allowed by the rounded corner 4m of the tenon 4f which avoids the flat 3h. This rounded corner 4m also allows slide of the slider 7 on the tenon 4f which advantageously facilitates the folding and deployment of the folding rod 2 by limiting the friction between the slider 7 and the tenon 4f.

The invention is not limited to the examples described and represented. It is possible to consider other return means, such as a gas spring or elastic bands. In addition, any locking means of the return means can be incorporated into the mechanism: in the case of a compression spring, a rod, through or not, or any type of non-circular stop is capable of blocking the compression spring. In the case of a gas spring, any means of bonding (fixing, welding, gluing, etc.) creates a blocking means.

1. A system (1) with a folding connecting rod (2) with two segments connecting a frame (1a) and a leaf (1c), the system comprising:
a locking segment (3) and a free segment (4), each one of the locking segment (3) and a free segment (4) includes a fastening end (3a, 4a) and a hinge end (3b, 4b), the two segments being connected to each other at their hinged end (3b, 4b) by a rotating axis (6), the fastening ends (3a, 4a) connecting the folding connecting rod (2) and the frame (1a) and between the folding connecting rod (2) and the leaf (1c);
the locking segment (3) is rectilinear and comprises in a central area a locking device of a return device;
the free segment (4) comprises a rectilinear portion (4c) extending from the hinge end (4b);
a locking slider (7) sliding along the locking segment (3) and the rectilinear portion (4c) of the free segment (4) between a release position wherein the locking slider (7) is carried in its entirety by the locking segment (3) and a locking position wherein the locking slider (7) covers the hinge ends (3b, 4b), the return device positioning the locking slider (7) in the locking position;
wherein the free segment (4) comprises a curved portion (4d) in continuity with the rectilinear portion (4c), the curved portion (4d) bringing the locking slider (7) to a stop in the locking position and allowing minimum bulk for the free segment (4).

2. The system (1) according to claim 1, wherein the return device of the locking slider (7) is a compression spring (5).

3. The system (1) according to claim 2, wherein the locking device for the compression spring (5) is a circular stop (3c) arranged on the locking segment (3).

4. The system (1) according to claim 1, wherein the rectilinear portion (4c) of the free segment (4) is smaller than the locking slider (7) which covers the axis of rotation (6) in the locking position.

5. The system (1) according to claim 1, wherein the free segment (4) comprises a stop (4e) of the locking slider (7).

6. The system (1) according to claim 1, wherein the locking segment (3) comprises a mortise (3d) and the free segment (4) comprises a tenon (4f) joined by the axis of rotation (6) or vice versa.

7. The system (1) according to claim 6, wherein the tenon (4f) comprises at least one shoulder (4h).

8. The system (1) according to claim 7, wherein at least one shoulder (4h) comprises a locking stop (4i) in rotating of the free segment (4).

9. The system (1) according to claim 7, wherein at least one shoulder (4h) comprises a step (4j) at the end of rotation of the free segment (4).

10. The system (1) according to claim 7, wherein at least one shoulder (4h) comprises a chamfer (4k).

11. The system (1) according to claim 6, wherein the mortise (3d) comprises at least a right angle (3f) against the rotating locking stop (4i) when the segments are aligned and at least one round edge (3g) which avoids the rotating locking stop (4i).

12. The system (1) according to an claim 6, wherein the tenon (4f) comprises a right corner (4l) abutting against a flat (3h) between the branches (3e, 3e′) of the mortise (3d) in the locking position and a rounder corner (4m) avoiding the flat (3h).
